(19) United States
(12) Patent Application Publication
(10) Pub. No.: US 2026/0288073 A1
(43) Pub. Date: Sep. 24, 2026

(54) ELECTRONIC DEVICE AND TIMEPIECE

(71) Applicant: CASIO COMPUTER CO., LTD., Tokyo (JP)

(72) Inventor: Yoshiki NAKATSUKA, Tokyo (JP)

(21) Appl. No.: 19/572,083

(22) Filed: Mar. 19, 2026

(30) Foreign Application Priority Data
Mar. 21, 2025 (JP) 2025-047438

(51) Int. Cl. G04B 37/05; G04G 17/08

(52) U.S. Cl. CPC G04B 37/052; G04G 17/08

(57) ABSTRACT

An electronic device includes: a case that is tubular along a first direction, and includes a housing that is formed on an outer circumference of the case and opens on one side in the first direction; an exterior member disposed on an opening side of the housing in the case; and a buffer that is disposed extending over an area between an inner wall and an outer wall forming the housing in the case, and an area that is outside the housing and between the outer circumference of the case and the exterior member.

### CROSS-REFERENCE TO RELATED APPLICATION

This application claims priority and benefit of Japanese Patent Application No. 2025-047438, filed on Mar. 21, 2025. The entire disclosure of Japanese Patent Application No. 2025-047438, filed on Mar. 21, 2025, including description, claims, drawings and abstract is incorporated herein by reference.

### BACKGROUND OF THE INVENTION

### TECHNICAL FIELD

The present disclosure relates to an electronic device and a timepiece.

### DESCRIPTION OF RELATED ART

JP2000258560 (A) describes a wristwatch case with a metal inner body (case), a metal outer body (bezel) that partially covers the inner body, and a cushioning member that is held between the inner and outer bodies.

### SUMMARY OF THE INVENTION

According to an aspect of the present disclosure, there is provided an electronic device comprising:

a case that is tubular along a first direction, and includes a housing that is formed on an outer circumference of the case and opens on one side in the first direction;

an exterior member disposed on an opening side of the housing in the case; and

a buffer that is disposed extending over an area between an inner wall and an outer wall forming the housing in the case, and an area that is outside the housing and between the outer circumference of the case and the exterior member.

### BRIEF DESCRIPTION OF THE DRAWINGS

FIG. 1 is a diagram showing the main part external view of a timepiece according to an embodiment.

FIG. 2 is a cross-sectional view of the main parts along the II-II line in FIG. 1.

FIG. 3 is an exploded diagram of the main parts of the timepiece according to the embodiment.

FIG. 4 is an enlarged main part view of the housing and its surrounding area in the embodiment.

FIG. 5 is an enlarged cross-sectional view of the main parts on the right side in FIG. 2.

FIG. 6 is a cross-sectional view of the main parts illustrating the deformation of a case and a buffer when the timepiece is dropped from the lateral side of the case.

FIG. 7 is a cross-sectional view of the main parts showing an example of a conventional timepiece.

### DETAILED DESCRIPTION

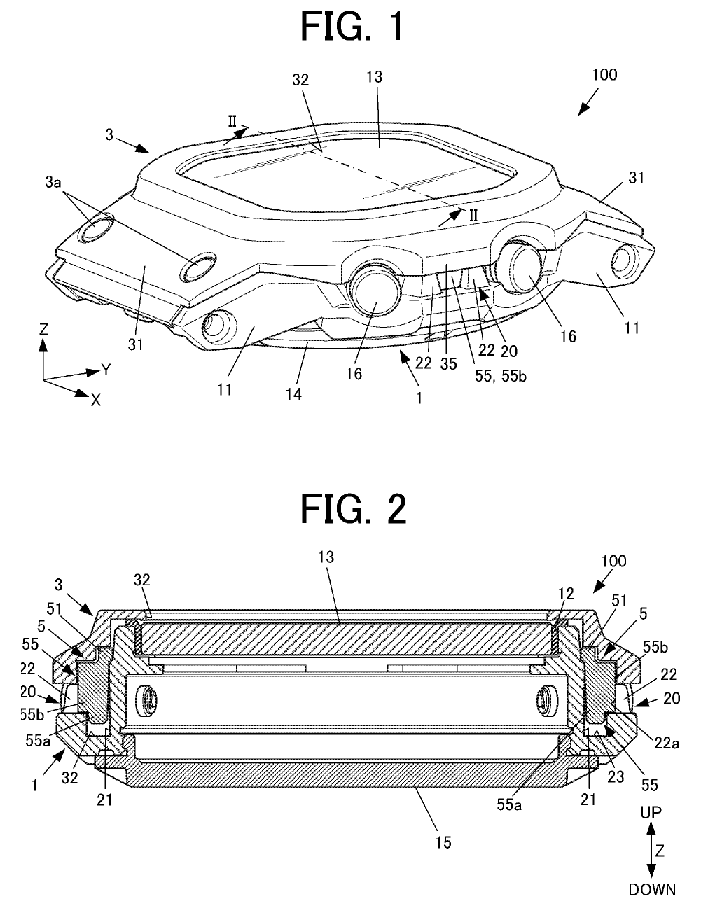

With reference to FIGS. 1 through 6, an embodiment of an electronic device and a timepiece of the present disclosure will be described. In the embodiment described below, the case in which the electronic device is applied to a wristwatch worn on the wrist (hereinafter referred to as "timepiece 100") will be used as an example. In the following description, each of the XYZ directions in the timepiece 100 refers to the orientation shown in FIG. 1. In other words, the x direction refers to the 3 o'clock - 9 o’clock direction on an analog timepiece, and the Y direction refers to the 12 o'clock - 6 o’clock direction. The Z direction is the thickness direction (up-down direction) of the timepiece 100 and is the first direction of the case 1. In the Z direction, the front side, which is the visible side, is referred to as the "upper side (up)" and the rear side as the "lower side (down). The direction orthogonal to the central axis of the case 1 (not shown) along the Z direction is referred to as the "radial direction" and the direction of rotation about the central axis is referred to as the "circumferential direction," with the side closer to the central axis in the plane perpendicular to the central axis referred to as the “inner side (inner diameter side)" and the side farther away referred to as the “outer side (outer diameter side). The following embodiments are subject to various technically preferred limitations for implementing the present disclosure, but the scope of the present disclosure is not limited to the following embodiments and illustrated examples.

As shown in FIG. 1, the timepiece 100 includes case 1, exterior member 3, and buffer 55. In the embodiment, the case 1 of the timepiece 100 is almost rectangular in front view, but the shape and external design of the timepiece is not limited to the illustrated example.

The case 1 is tubular along the Z direction (first direction), which is the thickness direction of the timepiece 100, and is a hollow short column shape with openings at the top and bottom in the Z direction. The opening 12 (see FIG. 2, and the like) in the upper side of the case 1 (upper side in the Z direction, the visible side or surface side in the timepiece) is fitted with a windshield member 13 to close the opening 12. The windshield member 13 is a transparent member (cover member) formed, for example, of glass material or transparent resin material. On the lower side of the case 1 (lower side in the Z direction, back side in the timepiece 100), there is a back cover member 15 that closes the opening 14 on the back side. It is preferable that the windshield member 13 and the back cover member 15 are attached via a waterproof ring and the like. By interposing a waterproof ring or the like between the windshield member 13 or the back cover member and the case 1, the upper and lower openings of the case 1 are closed in an airtight condition. The case 1 and the back cover member 15 may be molded as a single piece, with no opening 14 on the underside of the case 1. FIG. 1, and the like are a schematic illustration of the timepiece 100, and does not show the exact shape, configuration, and the like.

In the embodiment, the case 1 is formed of various metallic materials, such as stainless steel (SUS) and titanium. The materials used to form the case 1 are not limited. The case 1 should be formed of some hard material and may be made of materials other than those shown in the examples. For example, it may be made of a hard synthetic resin such as a super engineering plastic such as polyarylate (PAR) or an engineering plastic such as polyacetal (POM).

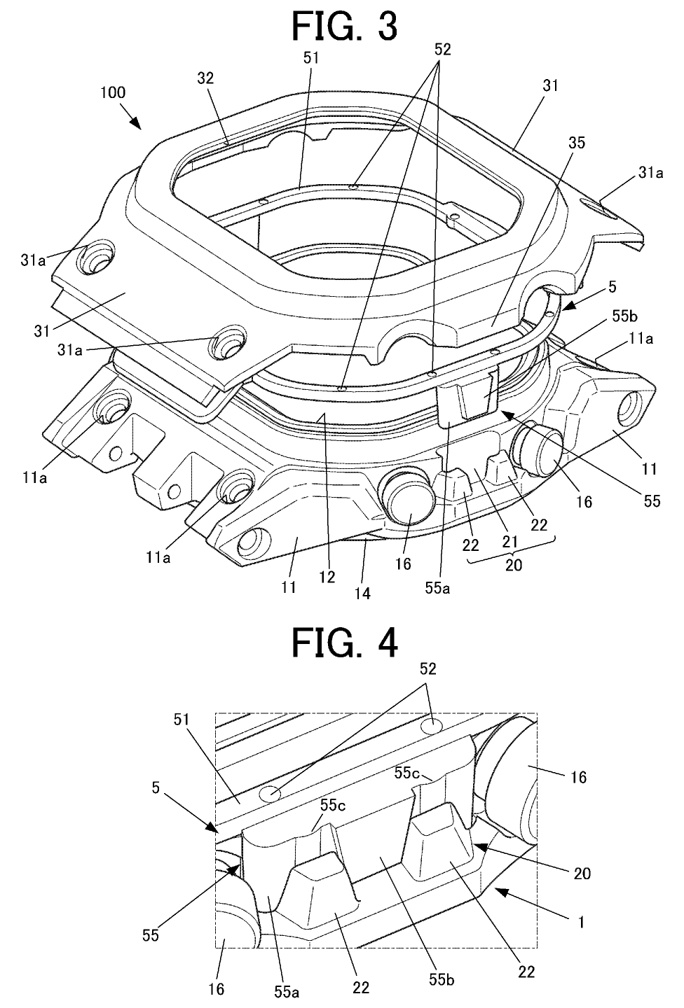

On the outer circumference of the case 1 (for example, the outer part of the timepiece at 3 o'clock or 9 o’clock side), there are operation sections 16 such as crowns and push buttons for various input operations by the user. In the outer part of the case 1, both lateral sides of the case 1 in the Y direction (12 o'clock - 6 o’clock direction) are provided with band attachments 11 respectively. The band attachment 11 is a part for connecting a band, not shown in the figure, to the case 1. As shown in FIG. 3, it has screw holes 11a that are screwed to the cover 31 of the exterior member 3, described below. Furthermore, although not shown in the figure, various parts such as modules are housed in the hollow portion of the case 1. The specific configuration of the module is not described in detail, but when the timepiece 100 is an electronic timepiece, the module includes the various operating parts of the timepiece 100, the control part that controls these parts, the battery, and other components. The timepiece 100 may be equipped with an analog-type display with hands, and the like, not shown, or a digital-type display with, for example, a liquid crystal display.

In the embodiment, a housing 20 is formed on the outer circumference of the case 1, opening on one side in the Z direction, the first direction. In the embodiment, one side in the Z direction is the upper side of the case 1 (the upper side in the Z direction, the visible side or surface side in the timepiece). The number and location of the housing 20 are not limited, but in the embodiment, one housing is provided at each of the 3 o'clock and 9 o'clock sides of outer circumference of the case 1 (see FIG. 2). The housing 20 is a pocket-like recess or groove that is provided outward from the outer circumference of the case 1. The housing 20 has an inner wall and an outer wall, and a gap is formed between the inner and outer walls as a housing space. The inner wall forming the housing 20 is the outer circumferential wall 21 of the case, and the outer wall in the embodiment is a pair of vertical walls 22 that are located outside of the outer circumferential wall 21 of the case 1. Although the vertical wall 22 is divided into two parts in the embodiment, it is not necessary that it be divided into two parts, as long as the vertical wall 22 forms a pocket-like recess or groove between it and the outer circumferential wall 21. For example, the vertical wall 22 may be a single connection, or they may be divided into three or more sections.

As shown in FIGS. 3 and 4, the housing 20 houses the buffer 55 described below. In the embodiment, each of the vertical walls 22 has an approximately trapezoidal shape with a narrower width in the circumferential direction from the bottom side to the top side in the Z direction (first direction), and a gap is formed between the pair of 22 vertical walls with a narrower width in the circumferential direction as one goes to the bottom side. This makes it easier to position the buffer 55 by receiving the projection 55b of the buffer 55, described below, on the sloping surface between the vertical walls 22, and also regulates the position of the buffer 55 in the Z direction so that the projection 55b does not drop too low when the buffer 55 is disposed inside the housing 20. In the embodiment, at least a partial area of the outer wall of the housing 20, the vertical wall 22, is elastically deformable. In other words, if a timepiece falls from the vertical wall 22 portion or the like, the 22 vertical wall deforms so that it falls inward, crushing the 55 buffer contained in the housing 20 (see FIG. 6). In the embodiment, at least part of the vertical wall 22, which is the outer wall of housing 20 of the case 1, is covered by an exterior member 3, described below.

The exterior member 3 is disposed on the upper (visible) side of the timepiece 100, one side of the case 1 in the Z direction (first direction). In the embodiment, the exterior member 3 is a bezel that is placed over the top of the case 1. The exterior member 3 is formed of various metal materials, such as stainless steel (SUS) and titanium. Since the exterior member 3 constitutes the appearance of the timepiece 100, it can be formed of metal material to achieve a luxurious appearance design. The materials used to form the exterior member 3 are not limited to those illustrated here. For example, the exterior member 3 may be made of glass, ceramic, and the like. The exterior member 3 of the embodiment has an opening 32 that exposes windshield member 13.

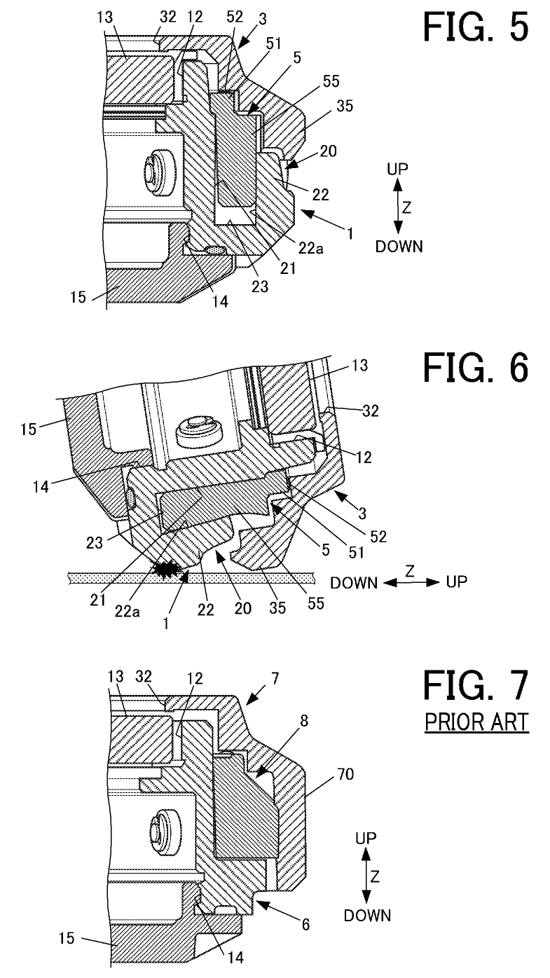

The exterior member 3 has a cover 31 that covers the band attachment 11 of the case 1 at the portion corresponding to the band attachment 11 when attached to the case 1. The cover 31 of the exterior member 3 has screw holes 31a in a position corresponding to the screw holes 11a of the band attachment 11, and by inserting the screws 3a into the screw holes 31a and the screw holes 11a from above the cover 31 of the exterior member 3, the exterior member 3 is secured to the case 1 as illustrated in FIG. 1. The method of attaching the exterior member 3 to the case 1 is not limited to this. In addition, the sides of both ends in the X direction (3 o'clock and 9 o'clock sides of the timepiece 100) in the exterior member 3 are provided with extensions 35 that extend from the top of the case 1 to the lateral side. In the embodiment, the extension 35 extends to the lower side in the Z direction (first direction) to the extent that it slightly overlaps the upper end in the Z direction (first direction) of the vertical wall 22 forming the housing 20 of the case 1, as shown in FIG. 5.

As shown in FIG. 3, when viewed in terms of position in the Z direction (first direction), an annular buffer member 51 along the circumferential direction of the case 1 is disposed between the surface on one side (top in the embodiment) of the case 1 in the Z direction (first direction) and the exterior member 3. The upper side surface of the annular buffer member 51 in the Z direction (first direction) faces the lower surface of the exterior member 3, and projections 52 protruding toward the exterior member 3 are formed on the surface facing the exterior member 3 at substantially equal intervals along the circumferential direction. When the case 1 and exterior member 3 are secured by screws 3a, the annular buffer member 51 with the projection 52 is sandwiched between the case 1 and exterior member 3 and makes point contact with the exterior member 3. When an impact is applied from the upper side of the exterior member 3, the impact is dispersed and absorbed by the crushing of the projection 52, providing a cushioning effect.

In the embodiment, a buffer 55 hangs from the points corresponding to the 3 o'clock and 9 o'clock sides of the timepiece 100 in the annular buffer member 51, toward the other side of the case in the first direction (below the case 1). In the embodiment, the annular buffer member 51 and buffer 55 are integrally constructed, and the annular buffer member 51 and buffer 55 together are referred to as cushioning member 5. The annular buffer member 51 and buffer 55 may be constructed separately. It is preferable that at least buffer 55, of the cushioning members 5, is made of deformable resin material. It is sufficient that the buffer 55 is able to be distorted and deform to some degree when pressed, and the specific material is not limited.

The buffers 55 are inserted into the housings 20 formed at 3 o'clock and 9 o'clock sides of the case 1, respectively, when the annular buffer member 51 is placed on the upper side surface of the case 1 in the Z direction (first direction). The buffer 55 has a buffer body 55a hanging from the annular buffer member 51 and a projection 55b protruding from the buffer body 55a toward the outer radial direction of the case 1. In the embodiment, the length of the projection 55b in the Z direction (first direction) is shorter than the length of the buffer body 55a. As shown in FIGS. 3 and 4, the projection 55b has an inverted trapezoidal shape that becomes narrower toward the bottom in the Z direction and fits between a pair of vertical walls 22 that constitute the outer wall of housing 20. The projection 55b fits between the pair of vertical walls 22, which defines the position of the buffer 55 in the Z direction (first direction). As mentioned above, the length of the buffer body 55a in the Z direction (first direction) is longer than the projection 55b, but the projection 55b does not fall too far in the Z direction (first direction), so that in a state in which the buffer 55 is inserted in the housing, a gap exists between the insertion-side end of the buffer 55 and the bottom surface 23 of the housing 20 (see FIGS. 2 and 5).

On both sides across the projection 55b, a protrusion 55c along the Z direction is formed, provided outward on the same side as the projection 55b. In a state in which the buffer 55 is housed in the housing 20, each protrusion 55c (projection) is disposed in a position corresponding to the pair of vertical walls 22, the outer walls, and is pressed against the inner surface of the vertical wall 22. In other words, the buffer 55 is press-fitted (lightly press-fitted) into the housing 20, and the protrusion 55c is a projection that is pressed against the inner surface of the outer wall of the housing 20. Thus, when the housing 20 accommodates the buffer 55, there is no gap between the inner and outer walls of the housing 20. In a state in which the annular buffer member 51 is disposed between the case 1 and the exterior member 3, the extension 35 of the exterior member 3 covers the upper side of the buffer 55 contained in the housing 20, blocking the opening side of the housing 20. In this state, the buffer 55 is disposed extending over an area between the outer circumferential wall 21 of the case 1, which is the inner wall forming the housing 20 of the case 1, and the pair of vertical walls 22, which are the outer walls, and an area that is outside the housing 20 and between the outer circumference of the case 1 (outer circumferential wall 21) and the exterior member 3 (extension 35) (FIG. 5).

Next, the action of the timepiece 100, which is an electronic device of this embodiment, will be described. To assemble the timepiece 100 in this embodiment, the module is housed in the case 1, and the opening 12 on the visible side is closed with the windshield member 13, and the opening 14 on the non-visible side is closed with the back cover member 15. Then, as shown in FIG. 3, for example, a cushioning member 5 is disposed between the case 1 and the exterior member 3. More specifically, the annular buffer member 51 is placed on the upper side surface of the case 1 in the Z direction (first direction), and the buffer 55 hanging from the 3 o'clock and 9 o'clock sides of the annular buffer member 51 is inserted into the housing 20 of the case 1.

When housing the buffer 55 in the housing 20, the projection 55b is positioned between the pair of vertical walls 22, and the protrusion 55c, which protrudes outward from the buffer body 55a, is inserted into the housing 20 with some crushing, and the protrusion 55c is disposed inside the pair of vertical walls 22, respectively. In a state in which the buffer 55 is housed in the housing 20, the protrusion 55c is pressed against the inner surface of the outer wall, the pair of vertical walls 22, and there is no gap between the inner wall (outer circumferential wall 21 of the case 1) and outer wall (vertical wall 22) of the housing 20.

The Z direction (first direction) of the projection 55b is positioned by fitting the projection 55b into the gap formed between the pair of vertical walls 22, and the buffer body 55a also does not drop lower than a predetermined level. As shown in FIG. 5, the lower end of the buffer body 55a, which is the insertion-side end of the buffer 55, is not in contact with the bottom surface 23 of the housing 20, leaving some gap.

Once the annular buffer member 51 and buffer 55 of the cushioning member 5 are disposed in a predetermined position, the exterior member 3 is secured to the case 1 by inserting screws 3a into the screw holes 31a and 11a from above the cover 31 of the exterior member 3. In this state, the exterior member 3 of the embodiment covers the upper side of the case 1 extensively, but the lateral side is covered only to the extent that the extension 35 is provided. Thus, the underside of the case 1 is not covered by the exterior member 3 and is exposed (see FIG. 5). The buffer 55 is disposed extending over an area between the inner wall (outer circumferential wall 21 of the case 1) and the outer wall (vertical wall 22) forming the housing 20 of the case 1, and an area that is outside the housing 20 and between the outer circumference of the case 1 (outer circumferential wall 21) and the exterior member 3 (extension 35) (see FIG. 5).

For example, as shown in FIG. 6, if the timepiece 100 in the embodiment is dropped from the lateral surface of the timepiece 100, such as 3 o'clock or 9 o’clock side, and the lower side of the timepiece 100 hits the floor or other object strongly, the impact is transmitted to the timepiece 100 from the point where it hits (the area shown in black in FIG. 6). At this time, the outer wall of housing 20 (vertical wall 22), which is in the outermost in the embodiment, deforms and falls inward, crushing the buffer 55 disposed inside housing 20. As mentioned above, in the embodiment, the protrusion 55c is pressed against the inner surface of a pair of vertical walls 22, which are outer walls, so that there is no gap between the inner wall (outer circumferential wall 21 of the case 1) and outer wall (vertical wall 22) of housing 20. Therefore, when impacted from the outside, the outer wall (vertical wall 22) immediately begins to crush the buffer 55, and the shock is absorbed and mitigated by the buffer 55 before the shock is transmitted inside the case 1. The gap between the insertion-side end of the buffer 55 and the bottom surface 23 of the housing 20 allows the vertical wall 22 to collapse easily when subjected to an external shock, and also provides space for the buffer 55 to deform. This enables smooth shock absorption.

If the timepiece 100 is dropped from the upper side in the Z direction and receives an impact, the impact is absorbed by the annular buffer member 51 of the cushioning member 5. In other words, the annular buffer member 51 of the embodiment is in contact with the exterior member 3 at a plurality of projections 52, rather than at a surface. This allows the shock to be distributed to a plurality of points and absorbed effectively. The band attachments 11 are provided on the 12 o'clock and 6 o'clock sides of the timepiece 100, to which a band is attached. Therefore, the band can absorb the shock when the timepiece 100 is dropped from the 12 o'clock and 6 o'clock sides. Thus, the timepiece of the embodiment can appropriately absorb and mitigate shocks and prevent them from being transmitted to the module housed inside the case 1, even if a shock is applied to the timepiece 100 from any direction.

On the other hand, if the cushioning member 8 is provided only between the case 6 and the exterior member 7 of the timepiece, as shown in FIG. 7, for example, if the timepiece is dropped from the lateral side, the cushioning member 8 can absorb the impact on the case 6 as long as the lateral surface 70 of the exterior member 7 is covered. However, if the timepiece is impacted from a point where the case 6 is exposed and not covered by the lateral surface 70 of the exterior member 7, the cushioning member 8 cannot absorb the impact and the impact is directly transmitted to the case 6 and the module inside the case 6, causing destruction. Therefore, a design that exposes the case 6 cannot be adopted, limiting the degree of freedom of design. In this regard, according to the configuration of the embodiment, even when the case 1 is designed to be exposed from the exterior member 3, the shock can be effectively absorbed and mitigated to avoid destruction of the timepiece 100.

As described above, the timepiece 100, which is an electronic device in this embodiment, includes a case 1 that is tubular along the Z direction, which is the first direction, and having a housing 20 formed on the outer circumference that opens on one side of the Z direction (upper side in the embodiment), an exterior member 3 disposed on the opening side of the housing 20 in the case 1, and a buffer 55 disposed extending over an area between the inner wall (outer circumferential wall 21 of the case 1) and the outer wall (vertical wall 22) forming the housing 20 of the case 1, and an area that is outside the housing 20 and between the outer circumference of the case 1 and exterior member 3. This allows the timepiece 100 to absorb and mitigate shocks even if it is dropped from the lateral surface, preventing modules and other precision devices in the case 1 from malfunctioning.

In addition, at least part of the vertical wall 22, which is the outer wall of the housing 20 of the case 1 in the embodiment, is covered by the exterior member 3. When configured in this way, impact resistance can be improved by that amount, at least for the portion covered by the exterior member 3.

The buffer 55 of the embodiment has a protrusion 55c as a projection that is pressed against the inner surface of the vertical wall 22, the outer wall of the housing 20. When housing the buffer 55 in the housing 20, insert the buffer 55 into the housing 20 by press-fitting it in or in a state close to it while crushing the protrusion 55c, so that there is no gap between the inner wall (outer circumferential wall 21 of the case 1) and outer wall (vertical wall 22) forming the housing 20 and the buffer 55. Thus, when an external shock is applied, the buffer 55 can immediately catch and absorb the shock, effectively avoiding the effects of the shock.

In the embodiment, in a state in which the buffer 55 is inserted in the housing 20, a gap is provided between the insertion-side end of the buffer 55 and the bottom surface 23 of the housing 20. As a result, the vertical walls 22 are prone to collapse when subjected to external impacts. Space for the buffer 55 to deform when the vertical wall 22 collapses is also provided. This allows smooth shock absorption.

It is preferable that at least a partial area of the outer wall of the housing 20, the pair of vertical walls 22, is elastically deformable. In the embodiment, the entire vertical wall 22 is deformed when impacted from the outside. The deformation may be plastic deformation, but it is preferred to be elastic deformation that returns to its original shape after the impact has subsided so as not to spoil the appearance of the timepiece 100.

In the embodiment, case 1 and exterior member 3 are formed of metal. This allows for a high-end appearance. Thus, even when the case 1 and exterior member 3 are formed of metal, the configuration of the embodiment allows the timepiece to be resistant to external shocks.

In the embodiment, the buffer is formed of a deformable resin material. This effectively absorbs shocks when they are applied, and avoids affecting the interior of the case 1.

In the embodiment, an annular buffer member 51 is disposed along the circumferential direction of the case 1 between the surface on one side (upper side) of the case 1 in the first direction, Z direction, and the exterior member 3, and the buffer 55 hangs from the annular buffer member 51 toward the other side (lower side) of the case 1 in Z direction. Thus, by placing a member with a buffering effect on the upper side of the case 1 in the Z direction as well, the shock can be absorbed when a shock is applied from the upper side of the timepiece 100, preventing the timepiece 100 from being destroyed. When the buffer 55 is an integral part hanging from the annular buffer member 51, the number of parts is reduced, which is superior in terms of assembly man-hours and ease of positioning.

When the electronic device of this embodiment is applied to the timepiece 100, excellent shock resistance can be achieved even when the case 1 is designed to be exposed from the exterior member, and the like. This allows for greater freedom of design and enables the realization of a timepiece 100 with excellent design.

Although an embodiment of the present disclosure is described above, it is needless to say that the present disclosure is not limited to the embodiment and various changes can be made without departing from the scope of the present disclosure. For example, the above embodiment illustrates a case in which two buffers 55 are provided in the cushioning member 5 and the housing 20 housing the buffers 55 is provided at 3 o'clock and 9 o'clock sides of the timepiece 100, but the number of buffers 55 and the housing 20 housing the buffers 55 are not limited to two. It may be more, or, for example, if an operation section or the like having a configuration with excellent cushioning effect is disposed at 3 o’clock side, the buffer 55 and the housing 20 housing the buffer 55 may be provided only at 9 o'clock side of the timepiece 100, and the like.

For example, the shape of buffer 55 is not limited to that shown in the embodiment. For example, the buffer 55 may consist only of the buffer body 55a and not have a projection 55b or the like. The size and shape of buffer 55 is also not limited to the illustrated example and can be changed as needed.

For example, the structure between the buffer 55 and the vertical wall 22, the outer wall of the housing 20 of the case 1, to fill the gap in the housing 20 is not limited to the protrusion 55c. It is sufficient that the buffer 55 have a projection that is pressed against the inner surface of the outer wall, the vertical wall 22, and the projection may be a hemispherical projection, for example, rather than a protrusion 55c that is long in the Z direction.

For example, the above embodiment illustrates a case in which the electronic device is applied to a timepiece 100, but the electronic device is not limited to a timepiece. Electronic devices can be any device where damage due to impact is a concern. For example, the configuration shown in the embodiment can be widely applied to electronic devices such as various types of smartwatches, sports watches, and other wearable devices that acquire biometric information such as heart rate and blood flow information as well as time.

Although some embodiments of the present disclosure have been described above, the scope of the present disclosure is not limited to the embodiments described above, but includes the scope of the invention described in the claims and its equivalents.

What is claimed is:

1. An electronic device comprising:
a case that is tubular along a first direction, and includes a housing that is formed on an outer circumference of the case and opens on one side in the first direction;
an exterior member disposed on an opening side of the housing in the case; and
a buffer that is disposed extending over an area between an inner wall and an outer wall forming the housing in the case, and an area that is outside the housing and between the outer circumference of the case and the exterior member.

2. The electronic device according to claim 1, wherein
at least part of the outer wall of the housing in the case is covered by the exterior member.

3. The electronic device according to claim 1, wherein
the buffer has a projection that is pressed against an inner surface of the outer wall of the housing.

4. The electronic device according to claim 1, wherein
in a state in which the buffer is inserted in the housing, a gap exists between an insertion-side end of the buffer and a bottom surface of the housing.

5. The electronic device according to claim 1, wherein
at least a partial area of the outer wall of the housing is elastically deformable.

6. The electronic device according to claim 1, wherein
the case and the exterior member are formed of metal.

7. The electronic device according to claim 1, wherein
the buffer is formed of a deformable resin material.

8. The electronic device according to claim 1, wherein
an annular buffer member along a circumferential direction of the case is disposed between a surface on the one side of the case in the first direction and the exterior member.

9. The electronic device according to claim 8, wherein
the buffer hangs from the annular buffer member toward the other side of the case in the first direction.

10. The electronic device according to claim 8, wherein
the annular buffer member has a plurality of projections protruding toward the exterior member along the circumferential direction.

11. A timepiece comprising
the electronic device according to claim 1.
